(19) United States
(12) Patent Application Publication
(10) Pub. No.: US 2009/0064134 A1
(43) Pub. Date: Mar. 5, 2009

(54) SYSTEMS AND METHODS FOR CREATING AND EXECUTING FILES

(75) Inventor: David P. Cox, Santa Barbara, CA (US)

Correspondence Address: Goodwin Procter LLP, Exchange Place, Boston, MA, 02109, US

(73) Assignee: Citrix Systems,Inc., Fort Lauderdale, FL (US)

(21) Appl. No.: 11/847,803

(22) Filed: Aug. 30, 2007

(51) Int. Cl. G06F 9/445

(52) U.S. Cl. 717/178; 717/174

(57) ABSTRACT

The invention generally relates to systems and methods for creating and executing files. In one embodiment, the file includes an executable program, a parameter for use by the executable program in subsequent operation, and an identifier that includes at least a first attribute computed from the executable program but not from the parameter. The first attribute is for facilitating subsequent detection of changes to the executable program but not for facilitating detection of changes to the parameter.

### TECHNICAL FIELD

The invention generally relates to systems and methods for creating and executing files. More particularly, the invention relates systems and methods for creating, modifying, and executing digitally-signed executable files.

### BACKGROUND

Many software companies develop and employ a varied set of files for their customers to download over the World Wide Web and execute, for example in order to receive, install, and/or activate some aspect or portion of their software. In view of the security risks associated with the World Wide Web, many of these software companies digitally sign their files so that their customers will know that the files were legitimately issued by the software companies and not created or modified by some other, potentially malicious, party. Without such a digital signature in a file, an operating system may warn a user against executing the file, which may deter the user from using the file.

Typically, a cryptographic digest is computed from the content of the file and encoded in the digital signature for the file. If the content of the file is then later modified, a cryptographic digest computed from the modified content of the file will almost always differ from the cryptographic digest encoded within the digital signature of the file. Facilities that check the integrity of digitally-signed files (for example, by computing a cryptographic digest from the content of a file and comparing it to the cryptographic digest encoded within the digital signature for the file) may, therefore, identify in certain instances that the file has been modified and communicate to the user that the file is untrustworthy. Moreover, these facilities may prevent the user from executing the file.

In some instances, however, there is a need to associate with the invocation of a program file a context that varies from one invocation to another and that guides the behavior of the program. For example, it may be necessary to vary the context based upon the particular service requested by a customer from among the services marketed by the software company, the identity of the customer on whose behalf the program is executed, the identity of the servers with which the software program may need to communicate, or any of a variety of other factors. Accordingly, many software companies have a need to pass some contextual information, such as arguments, to the program before or when it is to be executed. Often, those arguments can not be determined at the time the program file is created or digitally signed.

If a software company were to digitally sign a program file that is later modified with, for example, the inclusion of contextual information for subsequent invocation, the cryptographic digest computed from the modified program file will in almost all instances differ from the cryptographic digest encoded within the digital signature for the original program file. As described above, facilities on the customer's computer that check the integrity of digitally-signed files may, therefore, identify that the program file has been modified, communicate to the customer that the program file is untrustworthy, and/or even prevent the user from executing the program file.

Accordingly, in some instances, some known systems do not digitally sign program files whose content later needs to be modified. In these instances, however, customers may experience the above-mentioned warning from their operating system to refrain from executing the program file as it does not include a digital signature. While, in these instances, the customer may not actually be prevented from executing the program file, the customer may nevertheless be discouraged from doing so.

Customers may thus be dissuaded from using the software company's products, and the software company's reputation may also be tarnished. There exists, therefore, a need for new manners of creating, modifying, and executing program files.

### SUMMARY OF THE INVENTION

The present invention relates to systems and methods for creating, modifying, and executing digitally signed executable files. More specifically, in accordance with certain embodiments of the present invention, data within a copy of a program file, which is to be transmitted from a server to a client computer, is first modified so that the copy of the program file received by the client computer differs slightly from the program file stored on the server. For example, in some embodiments of the present invention, placeholder data within the copy of the program file is replaced with actual context argument values prior to the copy of the program file being downloaded to the client computer. The program code may be written so that when the modified program file is executed on the client computer, the client computer accesses the context arguments by reading them from a determined location within the program file.

In certain embodiments of the invention, as described in detail below, the program file is digitally signed prior to modification thereof, and the program file is then later modified, but in a manner that avoids modifying the data in the program file from which the cryptographic digest of the program file is computed. Accordingly, the present invention overcomes the previously described limitations of current systems.

In general, in one aspect, the invention features a file that includes an executable program, a parameter for use by the executable program in subsequent operation, and an identifier that includes at least a first attribute computed from the executable program but not from the parameter. The first attribute is for facilitating subsequent detection of changes to the executable program but not for facilitating detection of changes to the parameter. The parameter may be, for example, contextual information used in the subsequent operation of the executable program, such as an argument value, and may be stored in the file.

In various embodiments of this aspect of the invention, the file is configured to be downloaded over a network connection. In addition, the first attribute may be a cryptographic digest of at least a portion of the executable program, while the identifier may be a digital signature. In one embodiment, the parameter is present in the file before the file is downloaded to a user. For example, the parameter may be added to the file after the user initiates a download of the file. In one particular embodiment, the identifier includes the parameter.

In general, in another aspect, the invention features a method for creating a program file. In accordance with the method, a parameter is associated with an executable program and a first attribute is computed, from the executable program but not from the parameter, for an identifier. The parameter, which may be stored in the program file, is for use by the executable program in subsequent operation, while the first attribute is for facilitating subsequent detection of changes to the executable program but not for facilitating detection of changes to the parameter.

In general, in yet another aspect, the invention features a system for creating a program file. The system includes a modification module configured to associate, with an executable program, a parameter for use by the executable program in subsequent operation, and a file generation module configured to compute, from the executable program but not from the parameter, a first attribute for an identifier. The first attribute is for facilitating subsequent detection of changes to the executable program but not for facilitating detection of changes to the parameter.

Various embodiments of these latter two aspects of the invention include the following features, or implement modules for achieving the following features. The program file may be downloaded over a network connection. In addition, the parameter may be associated with the executable program after the computation of the first attribute. For example, the parameter may be associated with the executable program after a user initiates a download of the program file. Associating the parameter with the executable program may include replacing a placeholder in the program file with the parameter and/or writing the parameter into the program file. Moreover, computing the first attribute may include computing a cryptographic digest of at least a portion of the executable program. The parameter may also be stored within the identifier, which may be a digital signature.

In general, in still another aspect, the invention features a method for executing a file. In accordance with the method, a first attribute of an identifier associated with a file is read, an executable program is read from the file, a second attribute is computed from the executable program, and the first attribute is compared with the second attribute. When the first attribute and the second attribute match, the executable program is executed and, while doing so, at least one parameter from the file is utilized. In one embodiment, the first attribute and the second attribute are computed from the executable program, but not from the parameter. The parameter may be, for example, contextual information used in the subsequent operation of the executable program, such as an argument value.

In various embodiments of this aspect of the invention, the file is downloaded over a network. In addition, the first and second attributes may each be a cryptographic digest of at least a portion of the executable program. The at least one parameter may be stored within the identifier, which may be a digital signature.

In various embodiments of any of the above-described aspects of the invention, the file (i.e., the program file) is a Portable Executable (PE) format file. In these cases, the identifier may be an Attribute Certificate in an Attribute Certificate Table of the program file. Moreover, in these cases, the parameter may be stored at a location such as an entry in an Attribute Certificate Table of the program file, the file CheckSum field of the Windows-specific fields of the header of the program file, and the area past the end of the last section in the program file, which typically contains debugging information. The parameter may be stored in such locations because data stored in such locations is typically not included in the computation of a cryptographic digest for the program. Alternatively, the parameter may be stored in any other location designated, or known, to be excluded from the computation of a cryptographic digest for the program.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of an illustrative embodiment of a system for creating and executing files in accordance with the invention;

FIGS. 2A, 2B, and 2C are conceptual illustrations of embodiments of a file in accordance with the invention;

FIG. 3 is a flow diagram of an illustrative embodiment of a method for creating a file in accordance with the invention; and

FIG. 4 is a flow diagram of an illustrative embodiment of a method for executing a file in accordance with the invention.

### DESCRIPTION

In general, the present invention pertains to systems and methods for creating and executing files. In broad overview, in accordance with one aspect of the invention, a first computing device, for example a customer (or client) node, communicates with a second computing device, for example a software company's server, over a computer network. In one embodiment, the customer node initiates a download over the computer network of a digitally-signed file containing an executable program. Amongst other items, the digital signature for the file contains a cryptographic digest computed from the contents of the file. Prior to sending the digitally signed file to the customer node for execution of the program thereat, however, parameters are introduced into the file for use by the program in execution. In accordance with the invention, the file is modified in a manner that avoids modifying the data in the file from which the cryptographic digest of the file is computed. Accordingly, if, after downloading the file, the customer node itself computes a cryptographic digest for the file and compares it to the cryptographic digest encoded within the digital signature for the file, the two cryptographic digests will match and the program contained within the file may be executed at the customer node without concern. The executable program may also optionally utilize the parameters introduced into the file.

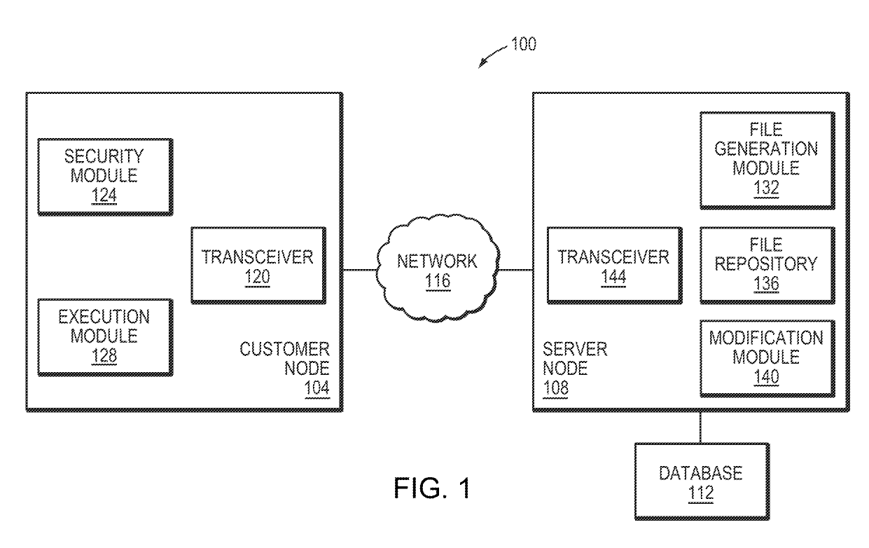

FIG. 1 depicts an exemplary system 100 for use in accordance with embodiments of the invention. The system 100 includes a customer node 104, a server node 108, a database 112, and a network 116 that enables communication between the customer node 104 and the server node 108 (and, optionally, as described below, with other components of the system 100). As illustrated, the customer node 104 may include a transceiver 120, a security module 124, and an execution module 128, while the server node 108 may include a file generation module 132, a file repository 136, a modification module 140, and a transceiver 144.

The network 116 may be, for example, a local-area network (LAN), such as a company Intranet, a metropolitan area network (MAN), or a wide area network (WAN), such as the Internet. Each of the customer and server nodes 104, 108 may be connected to the network 116 through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., HTTP, TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g, and direct asynchronous connections).

The customer node 104 may be any type of personal computer, Windows-based terminal, network computer, wireless device, information appliance, RISC Power PC, X-device, workstation, mini computer, main frame computer, personal digital assistant, set top box, handheld device, or other computing device that is capable of both presenting information/data to, and receiving commands from, a user of the customer node 104. The customer node 104 may include, for example, a visual display device (e.g., a computer monitor), a data entry device (e.g., a keyboard), persistent and/or volatile storage (e.g., computer memory), a processor, and a mouse. In one embodiment, the customer node 104 includes a web browser, such as, for example, the INTERNET EXPLORER program developed by Microsoft Corporation of Redmond, Wash., to connect to the World Wide Web.

For its part, the server node 108 may be any computing device capable of receiving information/data from and delivering information/data to the customer 104, for example over the network 116, and capable of querying and receiving information/data from the database 112. The database 112 may be any computing device (or component of the server node 108) capable of receiving commands/queries from and delivering information/data to the server node 108. In one embodiment, the database 112 stores and manages collections of data. The database 112 may communicate using SQL or another language, or may use other techniques to store and receive data.

The security module 124 and execution module 128 of the customer node 104, and the file generation module 132 and modification module 140 of the server node 108, may each be implemented as any software program and/or hardware device, for example an application specific integrated circuit (ASIC) or a field programmable gate array (FPGA), that is capable of providing the functionality described below. It will be understood by one having ordinary skill in the art that the illustrated modules and organization are conceptual, rather than explicit, requirements. For example, the security module 124 and execution module 128 may be combined into a single module, such that the functions performed by the two modules 124, 128, as described below, are in fact performed by the single module. Similarly, the file generation module 132 and modification module 140 may be combined into a single module, such that the functions performed by the two modules 132, 140, as described below, are in fact performed by the single module. In addition, it should be understood that any single one of the modules 124, 128, 132, and 140 may be implemented as multiple modules, such that the functions performed by any single one of the modules 124, 128, 132, and 140, as described below, are in fact performed by the multiple modules.

For their part, each transceiver 120, 144 may be any hardware device, or software module with a hardware interface, that is capable of receiving and transmitting communications, including requests, responses, and commands, such as, for example, inter-processor communications and networked communications. In another embodiment, the functions performed by the single customer node transceiver 120 may be performed by a separate client node receiver and transmitter (not shown). Similarly, the functions performed by the single server node transceiver 144 may be performed by a separate server node receiver and transmitter (not shown).

File repository 136 may be any hardware device, or software module with a hardware interface, that is capable of storing information, such as files generated by the file generation module 132, in accordance with the invention.

It will be understood by those skilled in the art that FIG. 1 is a simplified illustration of the system 100 and that it is depicted as such to facilitate the explanation of the present invention. Moreover, the system 100 may be modified in of a variety of manners without departing from the spirit and scope of the invention. For example, rather than being implemented on the server node 108, either or both the file generation module 132 and modification module 140 may be implemented on one or more other computing devices (not shown) and communicate with the server node 108 directly, over the network 116, or over another additional network (not shown). In addition, the collections of data stored and managed by the database 112 may in fact be stored and managed by multiple databases (not shown), or the functionality of the database 112 may in fact be resident on the server node 108. In yet another example, the server node 108 may be local to the customer node 104 and the two may communicate directly without the use of the network 116. As such, the depiction of the system 100 in FIG. 1 is non-limiting.

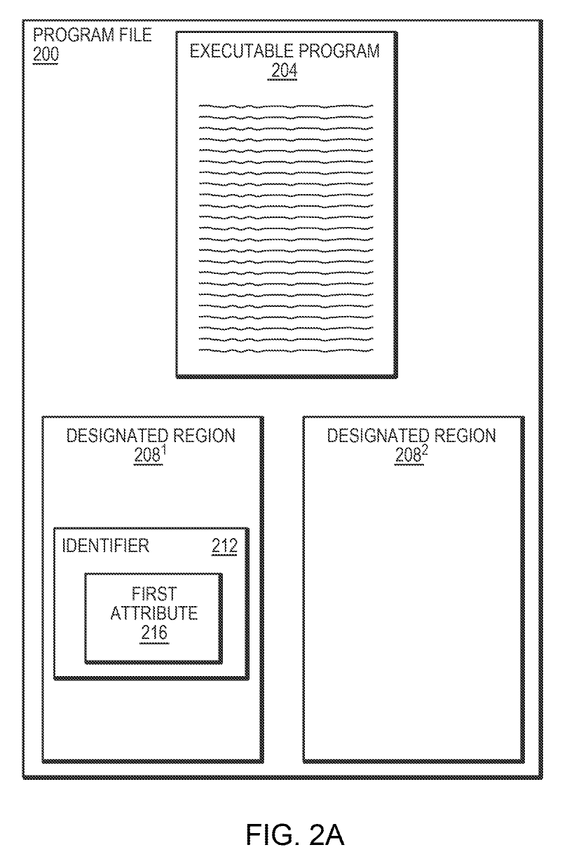

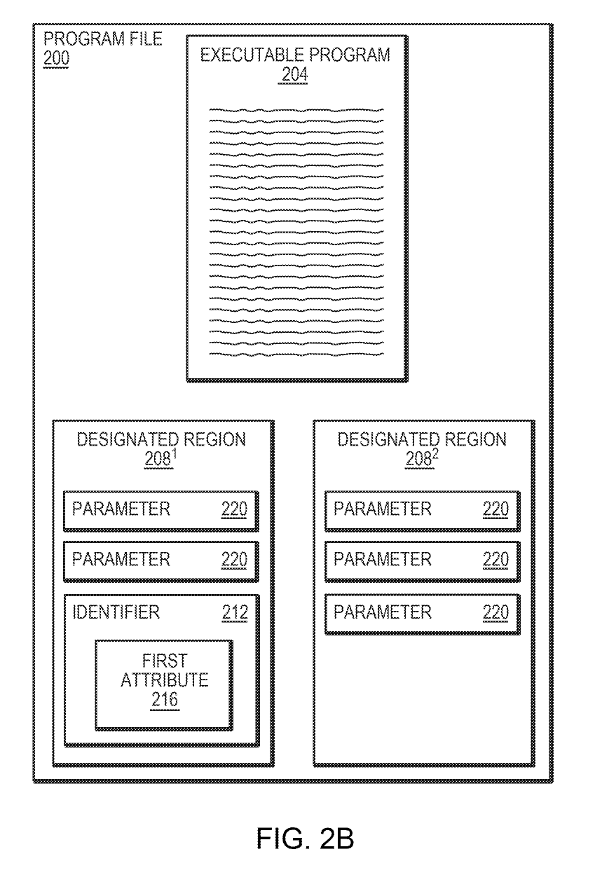

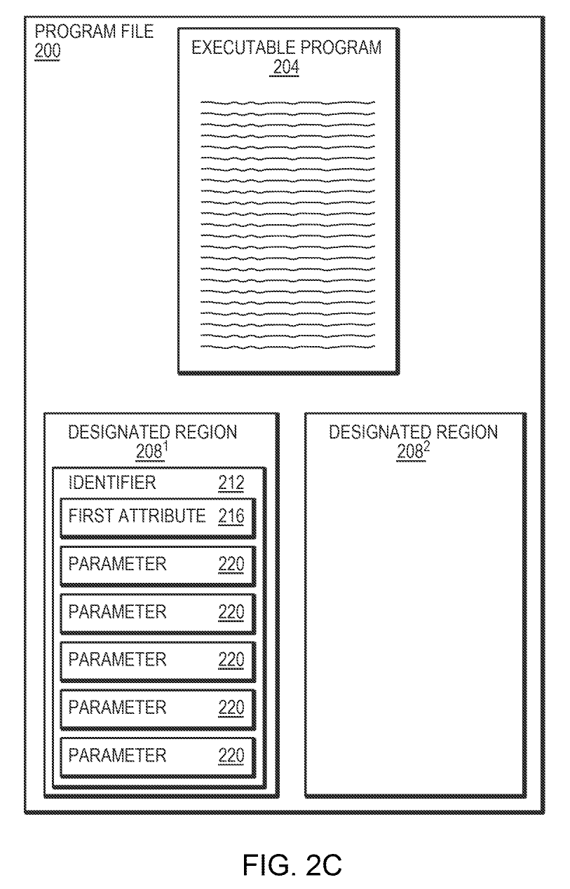

FIG. 2A is a conceptual illustration of an embodiment of a file 200 stored within the file repository 136 following generation by the file generation module 132, but prior to modification by the modification module 140. FIGS. 2B and 2C are conceptual illustrations of embodiments of the file 200 following modification thereof by the modification module 140.

Referring first to FIG. 2A, the file 200 includes, in one embodiment, an executable program 204, one or more designated regions 208 (for example, two designated regions 208¹, 208²), and an identifier 212. The identifier 212 may also include a first attribute 216 (or, for example, an encrypted version of the first attribute 216), whose purpose is described below. As illustrated in FIG. 2A, the executable program 204 may be stored in the file 200 outside of the designated regions 208, while the identifier 212, containing the first attribute 216, may be stored within one of the designated regions 208. In one embodiment, as explained below, data stored within the designated regions 208 is not considered when computing the first (or a subsequent) attribute 216 of the file 200.

Referring now to FIGS. 2B and 2C, following modification of the file 200 by the modification module 140, the file 200 further includes one or more parameters 220 stored within one or more of the designated regions 208. In one embodiment, the parameters 220 are for use by the executable program 204 in subsequent operation. For example, the parameters 220 may be argument values employed by the executable program 204 in execution. The particular parameters 220 stored by the modification module 140 within one or more of the designated regions 208 of the file 200 may be determined by the intended use of the file 200. For example, the parameters 220 may be different where the file 200 is downloaded for use in one country, or region of the world, as opposed to another country, or region of the world. As another example, the parameters 220 may be different for different users, or for users having different credentials, who request a download of the file 200. For example, the parameters 220 stored by the modification module 140 within one or more of the designated regions 208 of the file 200 may be different for a user who is a paying customer of a particular service than for a trial, or nonpaying, customer of the service. In yet another example, different parameters 220 may be stored within one or more of the designated regions 208 to give a different appearance, or look and feel, to different brands of a software company's program(s). The particular choice of parameters 220 may differ from one case to another for any of a variety of reasons. Exemplary parameters 220 include, but are not limited to, IP addresses, port numbers, and localized text.

In one embodiment, the first attribute 216 is computed from the executable program 204, but not from the one or more parameters 220, and facilitates subsequent detection of changes to the executable program 204, but does not facilitate detection of changes to data stored within the designated regions 208 (e.g., changes to the one or more parameters 220). In greater detail, the identifier 212 may be a digital signature for the file 200, the first attribute 216 contained (for example in an encrypted form) within the identifier 212 may be a cryptographic digest for the file 200, and the file format for the file 200 may specify that the first attribute 216 is to be calculated based only on the content of the file 200 outside of the designated regions 208 (e.g., based on the executable program 204). Thus, as further described below, so long as parameters 220 are added to, deleted from, or otherwise modified within the designated regions 208, such changes to the collection of parameters 220 will not be detected by comparing the first attribute 216 to a subsequently computed attribute for the file 200.

As will be understood by one of ordinary skill in the art, a cryptographic digest is, in general, the output of a cryptographic hash function, which may take a large amount of data of any length as input and produce a fixed-length string as output. A fundamental property of cryptographic hash functions is that if two outputs of the same cryptographic hash function are different, then the two inputs are necessarily different in some way. It is also highly likely, although not necessarily true, that, if two inputs to a cryptographic hash function are different, the corresponding outputs from the cryptographic hash function will differ. In addition, given a first input to a cryptographic hash function, it is very difficult to find a second input whose output from the hash function will be the same as that of the first input. Accordingly, the content of the file 200 outside of the designated regions 208 may serve as input to a cryptographic hash function, and the output therefrom (i.e., the cryptographic digest) may be employed in detecting changes to the executable program 204. In one embodiment, the systems and methods of the present invention employ the Authenticode Portable Executable (PE) file format developed by Microsoft Corporation of Redmond, Wash., to define the regions of the file 200 to be hashed (i.e., everything outside of the designated regions 208) and then employ any one of a number of industry standard hash functions, such as SHA1 or MD5, to compute the cryptographic digests described herein.

As an example, as illustrated in FIG. 2A, a file 200 storing an executable program 204 in an area outside of the designated regions 208 may be generated, a first attribute 216 (e.g., a cryptographic digest) calculated from the content of the file 200 outside of the designated regions 208 (e.g., from the executable program 204), and the first attribute 216 stored within one of the designated regions 208 (for example as part of an identifier 212 stored within the designated region 208¹). Subsequently, as illustrated in FIGS. 2B and 2C, parameters 220 may be added to one or more of the designated regions 208. Accordingly, if one were to calculate a second attribute (e.g., a second cryptographic digest) for the file 200 illustrated in FIGS. 2B and 2C based on the content of the file 200 outside of the designated regions 208, the second attribute would match the first attribute 216 stored within the file 200, as the parameters 220 were added to the designated regions 208 and the executable program 204 was not modified. Alternatively, if one were to modify the content of the file 200 outside of the designated regions 208 (e.g., modify a routine of the executable program 204) and then calculate a second attribute (e.g., a second cryptographic digest) for the file 200 based on the content of the file 200 outside of the designated regions 208, the second attribute would, in almost all instances, not match the first attribute 216 stored within the file 200. Accordingly, by storing and modifying parameters within the designated regions 208, the first attribute facilitates the detection of changes to the executable program 204, but does not facilitate detection of changes to the collections of parameter 220.

In one embodiment, the file 200 is a PE format file. The PE file format specifies that the cryptographic digest 216 used in the digital signature 212 is calculated based only on the data content in regions of the file 200 outside of the designated regions 208. In one embodiment, one of the designated regions 208, for example the designated region 208¹, is an Attribute Certificate Table, which the PE format describes as a variable length table of any number of Attribute Certificates. As illustrated in FIGS. 2A, 2B, and 2C, the identifier 212 (or, in some embodiments, digital signature 212) may be stored as an Attribute Certificate within the Attribute Certificate Table 208₁. In addition, as illustrated in FIG. 2B, a payload of parameters 220 may also be stored, in accordance with the invention, as one or more Attribute Certificates within the Attribute Certificate Table 208₁ of the file 200.

As illustrated in FIG. 2B, the parameters 220 may also (or alternatively) be stored in one or more other designated regions, for example designated region 208², that are not considered in computing the first attribute 216. Examples of these other designated regions 208₂ include the file CheckSum field of the Windows-specific fields of the header of the file 200 and the area past the end of the last section in the file 200 (which typically contains debugging information).

With reference now to FIG. 2C, in still another embodiment, the parameters 220 may be stored within the identifier 212 itself, which, as described, may be stored as an Attribute Certificate within an Attribute Certificate Table 208¹. More specifically, the identifier 212 may be a digital signature implemented as a variable-length data structure having authenticated and unauthenticated attributes. In such an embodiment, after the file 200 is generated by the file generation module 132, a first attribute 216 (e.g., a cryptographic digest) for the file 200 may be computed as described above, encrypted, and stored within the authenticated attributes of the identifier 212. Placeholder data may also be written to the unauthenticated attributes of the identifier 212 at that time. Then, when the modification module 140 is ready to insert the parameters 220 into the file 200, for example at some later time, the placeholder data stored within the unauthenticated attributes of the identifier 212 may be overwritten with the parameters 220. In some such embodiments, an additional cryptographic digest may also be computed from only the contents of the authenticated attributes of the identifier 212 (i.e., from the contents of the first attribute 216 and from any other data stored within the authenticated attributes of the identifier 212) and stored, for example in an encrypted form, in a separate field of the identifier 212 (i.e., in a field separate from the authenticated and unauthenticated attributes of the identifier 212). In such a fashion, changes to the authenticated attributes of the identifier 212 (e.g., to the first attribute 216) may also be subsequently detected. For example, a cryptographic digest from the contents of the authenticated attributes may be subsequently re-computed and compared to a decrypted value of the cryptographic digest stored in the separate field of the identifier 212. Where there is no match between the two, the content of the authenticated attributes of the identifier 212 (e.g., the first attribute 216) will be known to have been modified. Importantly, because the parameters 220 are stored to the unauthenticated attributes of the identifier 212, additions, deletions, and/or modifications to the parameters 220 may occur without detection.

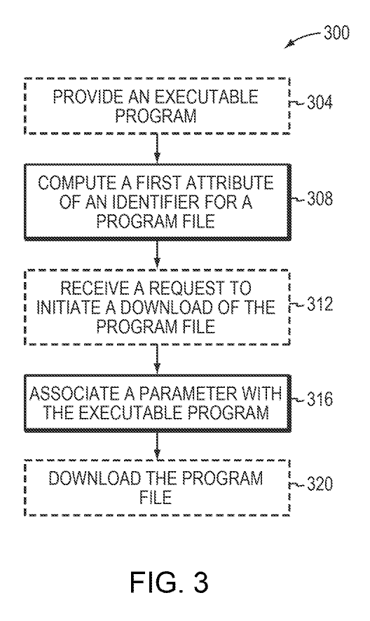

With reference now to FIG. 3, in one embodiment of a method 300 for creating the program file 200 depicted in FIGS. 2A, 2B, and 2C, for example using the system 100 of FIG. 1, a first attribute 216 of an identifier 212 is computed for the program file 200 at step 308 and a parameter 220 is associated with an executable program 204 at step 316. Optionally, the method 300 may also include providing the executable program 204 (step 304), receiving a request from the customer node 104 to initiate a download of the program file 200 (step 312), and downloading the program file 200 to the customer node 104 (step 320).

In greater detail, and with reference to FIGS. 1, 2A, 2B, 2C, and 3, an executable program 204 is provided at step 304. In one embodiment, the executable program 204 is written by a software engineer, for example by using the file generation module 132 present on the server 132 or by using another module on another computing device (not shown in FIG. 1) and then transmitting the executable program 204 to the file generation module 132. Once provided with the executable program 204, the file generation module 132 may insert the executable program 204 into an appropriate section of the program file 200 now being built.

At step 308, the file generation module 132 computes a first attribute 216 of an identifier 212 for the program file 200. As described above, the first attribute 216 may be a cryptographic digest computed from the content of the file 200 outside of the designated regions 208, and the identifier 212 may be a digital signature containing an encrypted version of the cryptographic digest. In one embodiment, the file generation module 132 computes the cryptographic digest from the executable program 204, encrypts the cryptographic digest, and stores the identifier 212, containing the encrypted version of the cryptographic digest, in a designated region 208 of the program file 200.

Before or after computing the first attribute 216, and before or after storing the identifier 212 in a designated region 208 of the program file 200, the file generation module 132 may optionally also write placeholder data for the parameters 220 into one or more of the designated regions 208. For example, placeholder data for the parameters 220 may be written into one or more of: i) an Attribute Certificate in an Attribute Certificate Table of the program file 200; ii) the file CheckSum field of the Windows-specific fields of the header of the program file 200; iii) the area past the end of the last section in the program file 200, which typically contains debugging information; and, iv) where the identifier 212 is a digital signature implemented as a variable-length data structure having authenticated and unauthenticated attributes, those unauthenticated attributes. Having stored the identifier 212 in a designated region 208 of the program file 200 and, optionally, inserted placeholder data for the parameters 220 into one or more of the designated regions 208, the file generation module 132 may then store the program file 200 in the file repository 136.

Some time later, at step 312, the server node 108 receives, over the network 116 and through the server node's transceiver 144, a request from the customer node 104 to initiate a download of the program file 200. In one embodiment, the request contains information identifying a context to be associated with the eventual invocation of the program file 200 on the client node 104 and that is to guide the behavior of the executable program 204. For example, the customer node 104 may request a particular service from among the services marketed by the owner of the server node 108 that calls for a particular context to be associated with the program file 200, the identity of the customer node 104 and/or the identity of servers with which the executable program 204 will need to communicate may call for a particular context to be associated with the program file 200, and/or any of a variety of other factors may call for a particular context to be associated with the program file 200.

In one embodiment, at step 316 and prior to downloading the program file 200 to the customer node 104, the modification module 140 associates with the executable program 204 one or more parameters 220, which may be obtained from the database 112. For example, having received from the customer node 104 the information identifying the context to be associated with the eventual invocation of the program file 200 on the client node 104, the modification module 140 may query the database 112 for the parameters 220 associated with that identifying information. Upon receipt of the parameters 220, the modification module 140 inserts the parameters 220 into one or more of the designated regions 208 of the program file 200. For example, the modification module 140 may replace (e.g., overwrite) existing placeholder data with the parameters 220 (e.g., placeholder data in the unauthenticated attributes of the identifier 212 may be overwritten to store the parameters 220 within the identifier 212), write the parameters 220 directly into empty fields in one or more of the designated regions 208 of the program file 200, perform some combination of the two, or even expand one or more of the designated regions 208 (and thus the file 200) into which to write the parameters 220.

As mentioned, the parameters 220 are for use by the executable program 204 in subsequent operation. In addition, the parameters 220 may be associated with the executable program 204 after computation of the first attribute 216 (at step 308) and after a user initiates (at step 312) a download of the program file 200. Nevertheless, because the first attribute 216 (e.g., a cryptographic digest) is computed, at step 308, from the content of the file 200 outside of the designated regions 208 (i.e., from the executable program 204, but not from the parameters 220), subsequently associating the parameters 220 with the program file 200 by inserting them into the designated regions 208 does not modify the data of the file 200 from which the cryptographic digest 216 of the program file 200 is computed. Accordingly, the first attribute 216 facilitates the subsequent detection of changes to the executable program 204, but does not facilitate detection of changes to the parameters 220.

In one embodiment, at step 320, once the parameters 220 have been included within the program file 200, the program file 200 is downloaded, for example over the network 116, to the client node 104 for execution thereat.

Alternatively, in another embodiment, rather than associating parameters 220 with the executable program 204 prior to downloading the program file 200 to the customer node 104, the program file 200 may be downloaded to the customer node 104 without any parameters 220. In such an embodiment, the parameters 220 for use by the executable program 204 may be separately downloaded to the customer node 104 (or otherwise obtained or determined) and associated, by the customer node 104, with the executable program 204. For example, the parameters 220 may be obtained over the network 116 from the server node 108, the database 112, or another computing device (not shown) upon, or just prior to, execution of the executable program 204 at the customer node 104.

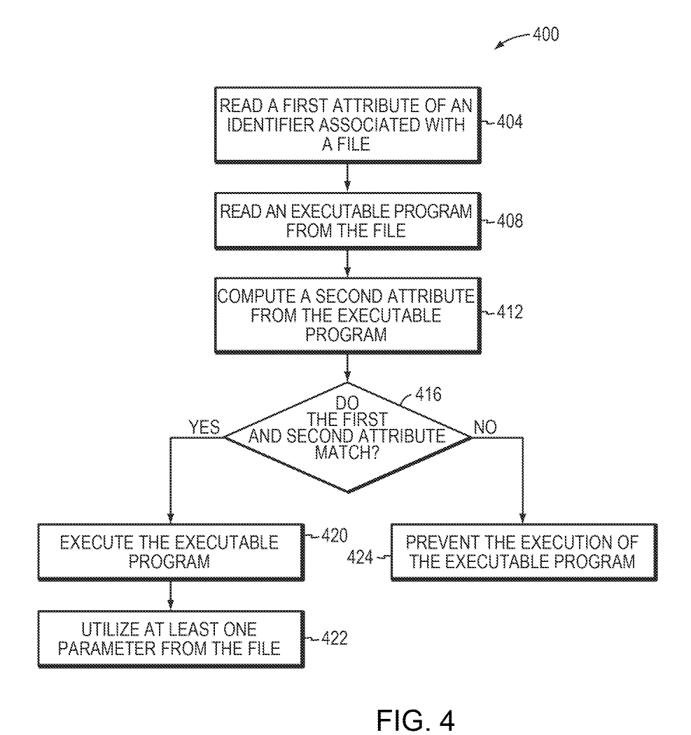

FIG. 4 depicts one embodiment of a method 400 for executing a program file 200 depicted in FIGS. 2A, 2B, and 2C. As will be understood by one of ordinary skill in the art, the method depicted in FIG. 4 may be initiated following the completion of the method 300 depicted in FIG. 3 (i.e., once the program file 200 is downloaded, at step 320, to the customer node 104). Using, for example, the system 100 of FIG. 1, the security module 124 of the customer node 104 may read, at step 404, the first attribute 216 of the identifier 212 associated with the program file 200. The security module 124 may also read, at step 408, the executable program 204 from the program file 200 and compute, at step 412, a second attribute from the executable program 204. More specifically, the security module 124 may be instructed, by the file format for the program file 200, to compute the second attribute (e.g., a second cryptographic digest) based only on the content of the file 200 outside of the designated regions 208 (i.e., from the executable program 204 and not from the parameters 220 located within the designated regions 208). The security module 124 may do so and may then compare, at step 416, the computed second attribute with the first attribute 216 of the identifier 212.

If, at step 416, the computed second attribute matches the first attribute 216, the execution module 128 of the customer node 104 may execute, at step 420, the executable program 204 of the program file 200. While executing, the executable program 204 may utilize, at step 422, at least one of the parameters 220 stored within the program file 200. In particular, functions and routines of the executable program 204 may, in their execution, employ argument values presented by the parameters 220. Alternatively, if, at step 416, the computed second attribute does not match the first attribute 216, the security module 124 may prevent, at step 424, the execution module 128 from executing the executable program 204 at the client node 104. In addition, the security module 124 may communicate to a user of the customer node 104, for example via a message displayed on a screen of the customer node 104, that the executable program 204 has been modified and that the program file 200 is, therefore, untrustworthy.

Accordingly, in addition to other advantages, the present invention, in one embodiment, allows parameters 220 for use by the executable program 204 in subsequent operation to be inserted into the program file 200 after the program file 200 has been digitally-signed, without altering the data from which a cryptographic digest of the program file 200 is computed. Thus, the customer node 104 may be provided with a usable, digitally-signed program file 200 to which parameters 220 (for example, parameters 220 specific to a particular user of a customer node 104) may be added just prior to the file 200 being downloaded to the user of the customer node 104. This presents many advantages, including the ability to tailor the behavior of the executable program 204 to the particular user.

It should also be noted that embodiments of the present invention may be provided as one or more computer-readable programs embodied on or in one or more articles of manufacture. The article of manufacture may be a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A file comprising:
an executable program;
a parameter for use by the executable program in subsequent operation; and
an identifier comprising at least a first attribute computed from the executable program but not from the parameter, the first attribute facilitating subsequent detection of changes to the executable program but not facilitating detection of changes to the parameter.

2. The file of claim 1, wherein the file is configured to be downloaded over a network connection.

3. The file of claim 1, wherein the first attribute is a cryptographic digest of at least a portion of the executable program.

4. The file of claim 1, wherein the identifier is a digital signature.

5. The file of claim 1, wherein the file is a Portable Executable (PE) format file.

6. The file of claim 5, wherein the identifier is an Attribute Certificate.

7. The file of claim 5, wherein the parameter is stored at a location selected from the group consisting of an entry in an Attribute Certificate Table of the file, the file CheckSum field of the Windows-specific fields of the header of the file, and an area past the end of the last section in the file.

8. The file of claim 1, wherein the identifier further comprises the parameter.

9. The file of claim 1, wherein the parameter is present in the file before the file is downloaded to a user.

10. The file of claim 1, wherein the parameter is added to the file after the user initiates a download of the file.

11. A method for creating a program file, the method comprising:
associating, with an executable program, a parameter for use by the executable program in subsequent operation; and
computing, from the executable program but not from the parameter, a first attribute for an identifier, the first attribute facilitating subsequent detection of changes to the executable program but not facilitating detection of changes to the parameter.

12. The method of claim 11 further comprising downloading the program file over a network connection.

13. The method of claim 11, wherein the parameter is associated with the executable program after the computation of the first attribute.

14. The method of claim 11, wherein the parameter is associated with the executable program after a user initiates a download of the program file.

15. The method of claim 11, wherein associating the parameter with the executable program comprises replacing a placeholder in the program file with the parameter.

16. The method of claim 11, wherein associating the parameter with the executable program comprises writing the parameter into the program file.

17. The method of claim 11, wherein computing the first attribute comprises computing a cryptographic digest of at least a portion of the executable program.

18. The method of claim 11, wherein the identifier is a digital signature.

19. The method of claim 11, wherein the program file is a Portable Executable (PE) format file.

20. The method of claim 19, wherein the identifier is an Attribute Certificate.

21. The method of claim 19 further comprising storing the parameter at a location within the program file selected from the group consisting of an entry in an Attribute Certificate Table of the program file, the file CheckSum field of the Windows-specific fields of the header of the program file, and an area past the end of the last section in the program file.

22. The method of claim 11 further comprising storing the parameter within the identifier.

23. A method for executing a file, the method comprising:
reading a first attribute of an identifier associated with a file;
reading an executable program from the file;
computing a second attribute from the executable program;
comparing the first attribute and the second attribute;
executing the executable program when the first attribute and the second attribute match; and
while executing the executable program, utilizing at least one parameter from the file,
wherein the first attribute and the second attribute are computed from the executable program but not from the parameter.

24. The method of claim 23, wherein the file is downloaded over a network.

25. The method of claim 23, wherein the first attribute and the second attribute each comprise a cryptographic digest of at least a portion of the executable program.

26. The method of claim 23, wherein the identifier is a digital signature.

27. The method of claim 23, wherein the file is a Portable Executable (PE) format file.

28. The method of claim 27, wherein the identifier is an Attribute Certificate.

29. The method of claim 27, wherein the at least one parameter is stored at a location selected from the group consisting of an entry in an Attribute Certificate Table of the file, the file CheckSum field of the Windows-specific fields of the header of the file, and an area past the end of the last section in the file.

30. The method of claim 23, wherein the at least one parameter is stored within the identifier.

31. A system for creating a program file, the system comprising:
a modification module configured to associate, with an executable program, a parameter for use by the executable program in subsequent operation; and
a file generation module configured to compute, from the executable program but not from the parameter, a first attribute for an identifier, the first attribute facilitating subsequent detection of changes to the executable program but not facilitating detection of changes to the parameter.

32. The system of claim 31, wherein the modification module is configured to associate the parameter with the executable program after the file generation module computes the first attribute.

33. The system of claim 31, wherein the modification module is configured to associate the parameter with the executable program after a user initiates a download of the program file.

34. The system of claim 31, wherein the modification module is configured to replace a placeholder in the program file with the parameter.

35. The system of claim 31, wherein the modification module is configured to write the parameter into the program file.

36. The system of claim 31, wherein the first attribute is a cryptographic digest of at least a portion of the executable program.

37. The system of claim 31, wherein the identifier is a digital signature.

38. The system of claim 31, wherein the program file is a Portable Executable (PE) format file.

39. The system of claim 38, wherein the identifier is an Attribute Certificate.

40. The system of claim 38, wherein the modification module is configured to store the parameter at a location within the program file selected from the group consisting of an entry in an Attribute Certificate Table of the program file, the file CheckSum field of the Windows-specific fields of the header of the program file, and an area past the end of the last section in the program file.

41. The system of claim 31, wherein the modification module is configured to store the parameter within the identifier.
